(19) United States
(12) Patent Application Publication
(10) Pub. No.: US 2004/0010102 A1
(43) Pub. Date: Jan. 15, 2004

(54) Bridged ylide group containning metal complexes

(76) Inventors: David D. Devore, Midland, MI (US); Jasson T. Patton, Midland, MI (US); Pamela J. Shapiro, Moscow, ID (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/381,933

(22) PCT Filed: Sep. 14, 2001
(86) PCT No.: PCT/US01/28735

(30) Foreign Application Priority Data
Oct. 24, 2000 (US) 60242876

(51) Int. Cl. C08F 4/44

(52) U.S. Cl. 526/127; 526/160; 526/161; 526/170; 526/172

(57) ABSTRACT

A metal complex corresponding to the formula (1) or (2) wherein: M is titanium, zirconium, or hafnium in the +4, +3, or +2 oxidation state; Y¹ and Y² are independently NR¹, PR¹, S, O, or an anionic, cyclic or non-cyclic, ligand group containing delocalized π-electrons; Z is boron, aluminium, gallium or indium.

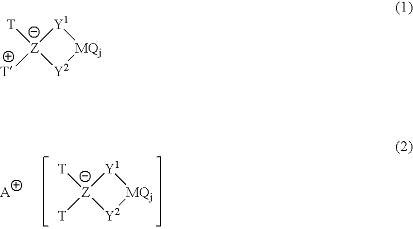

### BACKGROUND OF THE INVENTION

This invention relates to certain bridged Group 4 transition metal complexes possessing a unique bridging structure and to olefin polymerization catalysts obtained from such complexes. In one form, this invention embodies Group 4 transition metal complexes containing a unique bridged, or divalent ligand structure in which complexes a complete or partial charge separation exists. In a second embodiment the invention relates to the unique bridged ligands used to prepare the foregoing metal complexes. In a third embodiment the invention relates to catalyst compositions comprising the foregoing Group 4 transition metal complexes and their use in addition polymerization processes such as the polymerization of ethylene and optionally one or more olefins or diolefins to form polymeric products such as polyethylene.

In Angew. Chem. Int. Ed. Engl., 36, 21, p2338-2340 (1997) and in Phosphorus, Sulfur, and Silicon, 124 & 125, p561-565 (1997) amido substituted boron bridged ferrocenophanes useful for forming poly(ferrocenes) by a ring opening polymerization were disclosed. The synthesis and characterization of Group 1 and 2 metal and tin complexes of 1,2-bis(dimethylamino)-1,2-di-9-fluorenyldiboranes were disclosed in Chem. Ber., 127, p1901-1908, (1994). Diboranes having structure similar to those employed in the foregoing study were disclosed by the same researchers in Eur. J. Inorg. Chem., p505-509 (1998). Ferrocenophane derivatives of similar bisboranes for further molecular property studies were disclosed by J. Organomet. Chem., 530 p117-120 (1997). In Organometallics. 16, p4546-4550 (1997) boron bridged ansa metallocene complexes including dimethylsulfide and phosphine adducts thereof of possible use in Ziegler-Natta-type olefin polymerizations were disclosed.

In the patent literature, bridged metal complexes for use as olefin polymerization catalyst components, including such complexes containing one or more boron atoms in the bridge are generically disclosed by EP-A-416,815 and WO 98/39369. Zwitterionic ansa metaliocene (ZAM) complexes having a built-in anion co-catalyst functionality are disclosed in U.S. Pat. No. 5,939,503. The present complexes and ligands constitute an improvement and extension of such ZAM complexes.

### SUMMARY OF THE INVENTION

According to the present invention there are provided metal complexes corresponding to the following formulas:

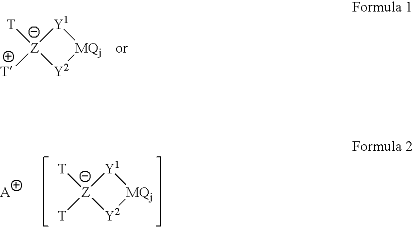

wherein:

M is titanium, zirconium, or hafnium in the +4, +3, or +2 oxidation state;

Y¹ and Y² are independently NR¹, PR¹, S, O, or an anionic, cyclic or non-cyclic, ligand group containing delocalized π-electrons;

Z is boron, aluminum, gallium or indium;

Q is a neutral, anionic or dianionic ligand group;

j is 1 or 2;

T independently each occurrence is an anionic ligand group, preferably NR¹₂, PR¹₂, hydrocarbyl, halohydrocarbyl,

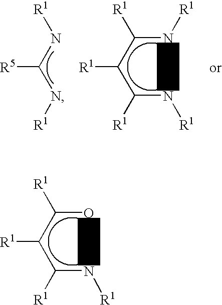

wherein:

R¹ is independently each occurrence hydrogen, a hydrocarbyl group, a halohydrocarbyl group, a tri(hydrocarbyl)silyl group, or a tri(hydrocarbyl)silylhydrocarbyl group, said R¹ groups containing up to 20 atoms not counting hydrogen;

R⁵ is R¹ or N(R¹)₂; and

two R¹ groups together or one or more R¹ groups together with R⁵ may optionally be joined to form a ring structure,

T′⁺ independently each occurrence is an ylide group corresponding to the formula:

R¹₃N⁺CH₂—, R¹₃P⁺CH₂—, R¹₂S⁺CH₂—, R¹₃P⁺NR—, R¹₂P⁺═NR—, N≡N⁺CH₂—, or R⁴₂M′⁺CH₂—, wherein R¹ is as previously defined;

R⁴ is a cyclic π-bonded hydrocarbyl group, preferably a cyclopentadienyl group;

M′ is a transition metal, preferably Ti, Zr, Hf, most preferably Ti;

and optionally T and T′⁺ are covalently bonded together; and

A⁺ is a cation, preferably an alkali metal-, alkaline earth metal-, Grignard-, or C₁₋₂₀ mono-, di- or tri-alkyl ammonium-cation.

It is understood that the foregoing metal complexes may exist as dimers and that one or more Lewis bases may optionally be coordinated with the complex or the dimer thereof. In addition, when T is R¹₂N and Z is boron, the bond between T and Z, particularly in the compounds of formula 1, may possess double bond characteristics, that is, the resulting group may more accurately be depicted by the formula R¹₂N═B.

Additionally, according to the present invention there are provided compounds based on the unique ligand structures of the foregoing complexes, said compounds having the formulas:

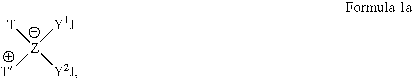

wherein:

Y¹ and Y² are independently NR¹, PR¹, S, O, or an anionic, cyclic or non-cyclic, ligand group containing delocalized π-electrons;

Z is boron, aluminum, gallium or indium;

Q is a neutral, anionic or dianionic ligand group;

j is 1 or 2;

T independently each occurrence is an anionic ligand group, preferably NR¹₂, PR¹₂, hydrocarbyl, halohydrocarbyl,

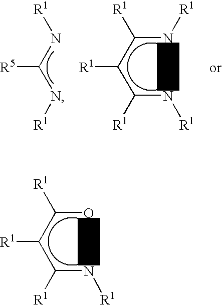

wherein:

R¹ is independently each occurrence hydrogen, a hydrocarbyl group, a halohydrocarbyl group, a tri(hydrocarbyl)silyl group, or a tri(hydrocarbyl)silylhydrocarbyl group, said R¹ groups containing up to 20 atoms not counting hydrogen;

R⁵ is R¹ or N(R¹)₂; and

two R¹ groups together or one or more R¹ groups together with R⁵ may optionally be joined to form a ring structure,

T′⁺ independently each occurrence is an ylide group corresponding to the formula:

R¹₃N⁺CH₂—, R¹₃P⁺CH₂—, R¹₂S⁺CH₂—, R¹₃P⁺NR—, R¹₂P⁺═NR—, N≡N⁺CH₂—, or R⁴₂M′⁺CH₂—, wherein R¹ is as previously defined;

R⁴ is a cyclic π-bonded hydrocarbyl group, preferably cyclopentadienyl;

M′ is a transition metal, preferably Ti, Zr, Hf, most preferably Ti;

and optionally T and T′⁺ are covalently bonded together;

J is hydrogen, or a trimethyltin or trinethylsilyl group, and

LB is a neutral, Lewis base, preferably of the formula, R⁷₃N, R⁷₃P, R⁷₂O, or R⁷₂S, wherein R⁷ is a C₁₋₁₂ hydrocarbyl group, more preferably a C₁₋₆ alkyl group or a phenyl group.

Such ligand groups of Formula 1a are readily prepared by contacting sources of the anionic groups Y¹ and Y², particularly the Grignard-, alkali metal- or alkaline earth-metal salts thereof, with the neutral compound TZY3 or T′⁺-ZTY³, where Y³ is a leaving group bound to Z, especially halide, either as neat reagents or in an inert solvent, optionally in the presence of a Lewis base, employing temperatures from −100° C. to 150° C., and subsequently, for reactions with TZY³, reacting the product with a source of the ylide, T′⁺.

Additionally, according to the present invention there is provided a process for preparing complexes of formula 1 and formula 2 in high racemic purity wherein M is titanium or zirconium in the +2 formal oxidation state by contacting ligand structures of formula 1a, 1b or 2a, or a deprotonated dianionic derivative thereof, with a Group 4 precursor of the formula 3:

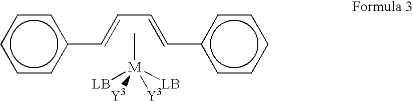

wherein,

M is titanium or zirconium in the +2 formal oxidation state,

LB is a neutral, Lewis base, preferably of the formula, R⁷₃N, R⁷₃P, R⁷₂O, or R⁷₂S,

wherein R⁷ is a C₁₋₁₂ hydrocarbyl group, more preferably a C₁₋₆ allyl group or a phenyl group, and

Y³ is a leaving group bound to Z, especially halide.

The reaction is desirably conducted in an inert solvent, especially an aliphatic or aromatic hydrocarbon or ether, employing temperatures from −100° C. to 150° C. This technique is similar to that disclosed in U.S. Pat. No. 6,084,115, differing in that different starting reagents are employed.

Alternatively, the complexes may be synthesized in high racemic purity by use of a chelating diamide ligand substantially in accordance with the technique disclosed in J. Am. Chem. Soc., 2000, 122, 8093-8094.

Further according to the present invention there are provided catalyst compositions suitable for the polymerization of addition polymerizable monomers comprising one or more metal complexes of formula 1 or 2 in combination with one or more activating cocatalysts or activated by the use of an activating technique. More particularly, the cocatalyst is an oligomeric or polymeric allylaluminoxane compound.

Finally, according to the present invention there is also provided a polymerization process comprising contacting one or more addition polymerizable monomers with a catalyst composition comprising one or more metal complexes of formula 1 or 2, in combination with one or more activating cocatalysts or activated by use of an activating technique. The polymerization is preferably performed under solution, slurry, suspension, bulk or high pressure process conditions, and the catalyst composition or individual components thereof may be used in a heterogeneous state, that is, a supported state or in a homogeneous state as dictated by process conditions. The catalysts of the present invention can be used in combination with one or more additional catalysts of the same or different nature either simultaneously or sequentially in the same or in separate reactors.

### DETAILED ESCRIPTION OF THE INVENTION

All references to the Periodic Table of the Elements herein shall refer to the Periodic Table of the Elements, published and copyrighted by CRC Press, Inc., 1997. Also, any references to a Group or Groups shall be to the Groups or Groups reflected in this Periodic Table of the Elements using the IUPAC system for numbering groups. By the term “π-bonded” as used herein is meant that bonding occurs through an interaction involving delocalized electrons. Finally, by the term, “leaving group” is meant a ligand that is readily displaced by another ligand under ligand exchange conditions.

The present Group 4 transition metal complexes contain a unique bridging group: (T-Z⁻-T′⁺), containing full or partial charge separation therein, which imparts improved catalytic properties when used to catalyze the polymerization of addition polymerizable monomers. While not desiring to be bound by theory, it is believed that the improvement in catalytic properties for such complexes may be due to the electronic properties of the metal complex resulting from the above bridging group.

Preferred Group 4 transition metal complexes of the present invention which correspond to formula 1 or 2 are represented in formulas 4, 5, 6, 7, 8 and 9:

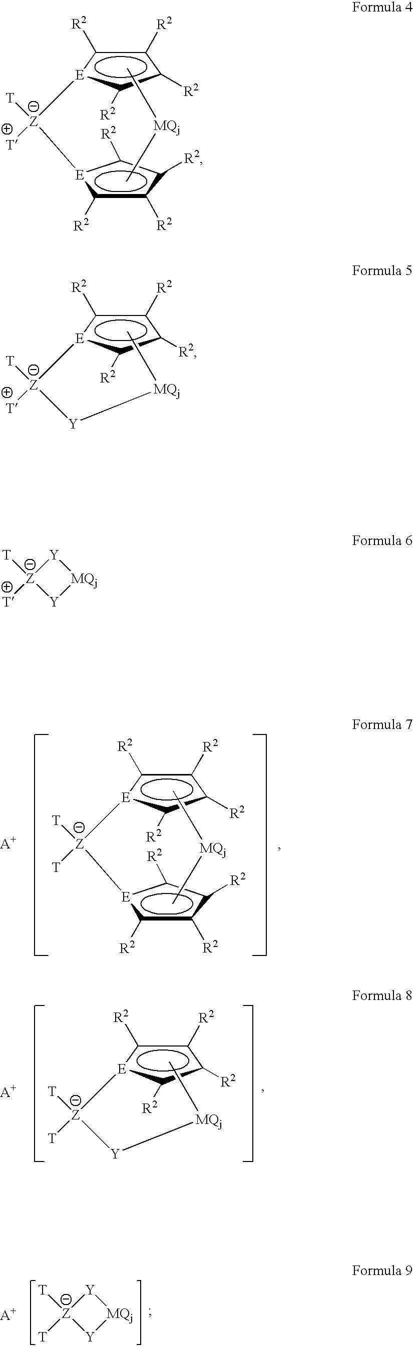

wherein,

A⁺, M, Z⁻, T, T′⁺, Q and j are as defined above;

E is carbon, nitrogen, or phosphorous;

Y is NR¹ or PR¹, where R¹ is as previously defined;

R² is hydrogen, or a hydrocarbyl, halohydrocarbyl, dihydrocarbylamino-hydrocarbyl, tri(hydrocarbylsilyl)hydrocarbyl, Si(R³)₃, N(R³)₂, or OR³ group of up to 20 carbon or silicon atoms, and optionally two adjacent R² groups can be joined together, thereby forming a fused ring structure, especially an indenyl ligand or a substituted indenyl ligand; and

R³ is independently hydrogen, a hydrocarbyl group, a trihydrocarbylsilyl group or a trihydrocarbylsilylhydrocarbyl group, said R³ having up to 20 atoms not counting hydrogen, and optionally two R³ groups may be joined to form a ring structure.

When M is in the +4 oxidation state, j=2 and Q independently each occurrence is halide, hydride, hydrocarbyl, silylhydrocarbyl, hydrocarbyloxide, dihydrocarbylamide, said Q having up to 20 atoms not counting hydrogen. Alternatively, j is 1 and Q is a dianionic ligand, such as a hydrocarbadiyl-, di(hydrocarbyl)silane, or hydrocarbylidene- group, especially a conjugated C₄₋₄₀ diene ligand which is coordinated to M in a metallocyclopentene fashion.

When M is in the +3 oxidation state, j=1 and Q is either 1) a monovalent anionic ligand selected from the group consisting of alkyl, cycloalkyl, aryl, silyl, amido, phosphido, alkoxy, aryloxy, sulfido groups, and mixtures thereof, optionally further substituted with an amine, phosphine, ether, or thioether containing substituent able to form a coordinate-covalent bond or chelating bond with M said ligand having up to 50 atoms not counting hydrogen; or 2) a C₃₋₁₀ hydrocarbyl group comprising an ethylenic unsaturation able to form an η³ bond with M.

When M is in the +2 oxidation state, j=1 and Q is a neutral conjugated diene, optionally substituted with one or more tri(hydrocarbyl)silyl or tri(hydrocarbylsilyl)hydrocarbyl groups, said Q having up to 40 carbon atoms and forming a π-complex with M.

Specific examples of the above metal complexes are shown in the following formulas:

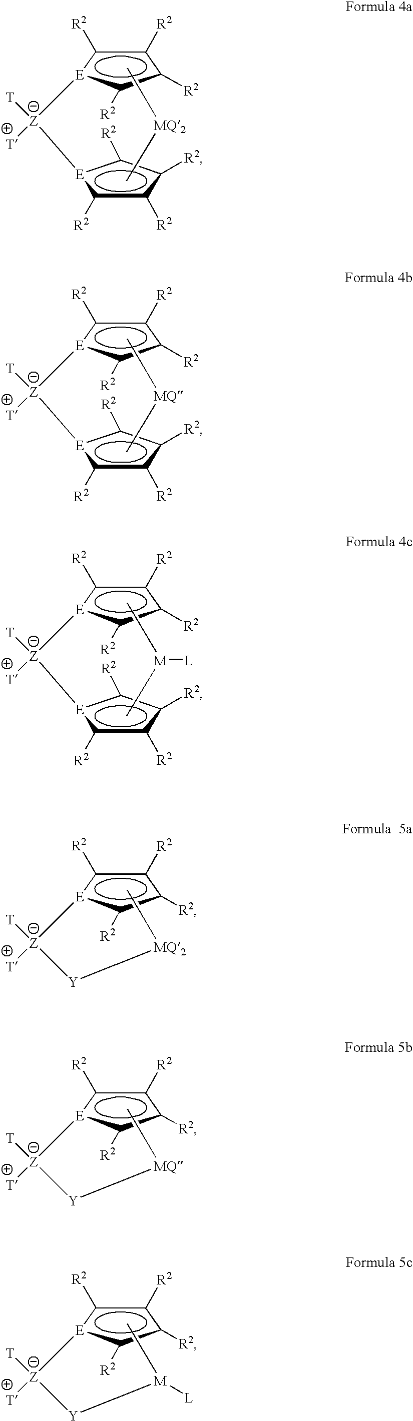

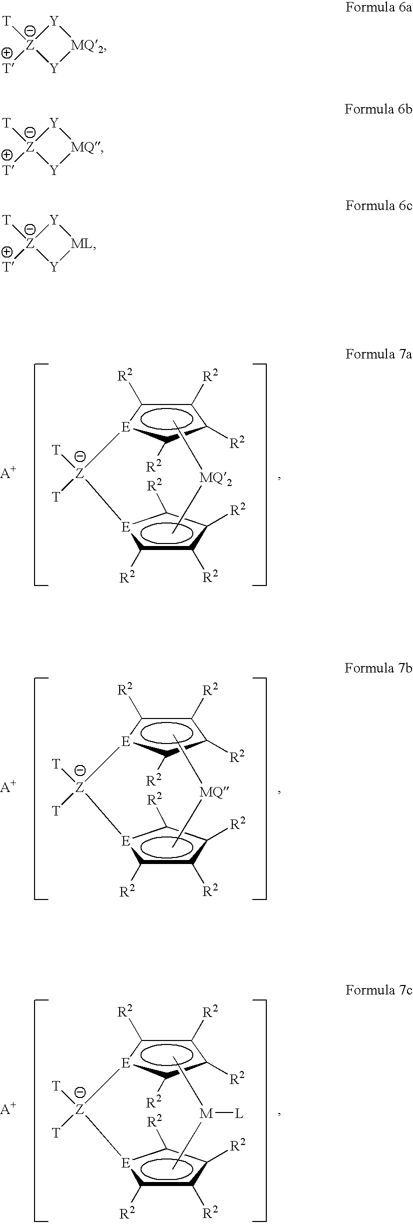

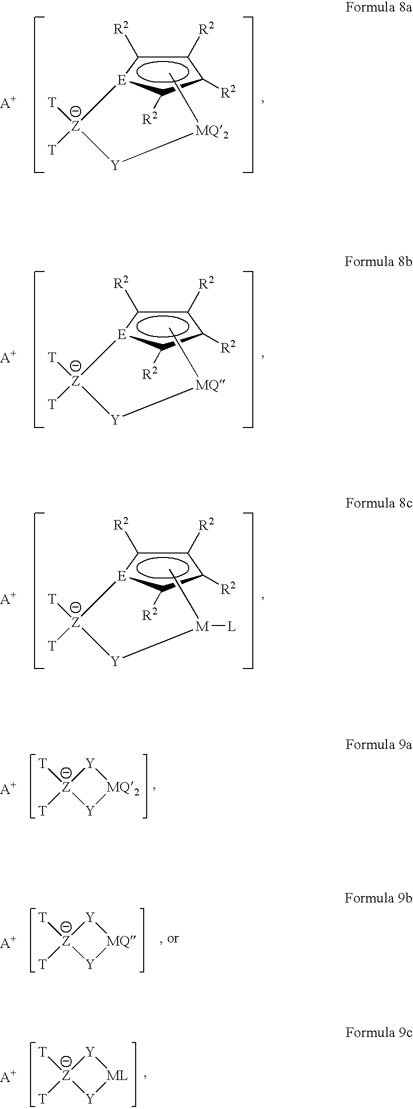

wherein:

M, Z⁻, T, T′⁺, Y, A⁺, E, and R² are as previously defined;

Q′, independently each occurrence is a halide, hydrocarbyl, hydrocarbyloxy, or dihydrocarbylamide group of up to 10 atoms not counting hydrogen, or two Q′ groups together form a C₄₋₂₀ diene ligand coordinated to M in a metallocyclopentene fashion, or together are: —CH₂—C₆H₄—CH₂— or —CH₂—Si(CH₃)₂—CH₂—;

Q″ is a monovalent anionic stabilizing ligand selected from the group consisting of alkyl, cycloalkyl, aryl, and silyl groups which are optionally substituted with one or more amine, phosphine, or ether substituents able to form a coordinate-covalent bond or chelating bond with M, said Q″ having up to 30 non-hydrogen atoms; or Q″ is a C₃₋₁₀ hydrocarbyl group comprising an ethylenic unsaturation able to form an η³bond with M; and

L is a neutral conjugated diene, optionally substituted with one or more tri(hydrocarbyl)silyl groups or tri(hydrocarbyl)silylhydrocarbyl groups, said L having up to 30 atoms not counting hydrogen and forming a π-complex with M.

Preferred Q′ groups are chloride and C₁₋₆ hydrocarbyl groups, or two Q′ groups together form a 2-methyl-1,3-butadienyl or 2,3-dimethyl-1,3-butadienyl group. Preferred Q″ ligands are 2-N,N-dimethylaminobenzene, allyl, and 1-methyl-allyl. Preferred L groups are 1,4-diphenyl-1,3-butadiene, 1,3-pentadiene, 3-methyl-1,3-pentadiene, 2,4-hexadiene, 1-phenyl-1,3-pentadiene, 1,4-dibenzyl-1,3-butadiene, 1,4-ditolyl-1,3-butadiene, 1,4-bis(trimethylsilyl)-1,3-butadiene, and 1,4-dinaphthyl-1,3-butadiene.

Preferably in the foregoing metal complexes,

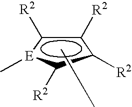

independently each occurrence is an unsubstituted, partially substituted or fully substituted indenyl-, fluorenyl-, indacenyl-, cyclopenta(l)phenanthrenyl-, or azuleneyl-group or a partially hydrogenated derivative thereof; or a partially or fully substituted cyclopentadienyl-, group, wherein each substituent is a hydrocarbyl-, halohydrocarbyl-, hydrocarbyloxy-, di(hydrocarbyl)amino-, hydrocarbyleneamino-, or silyl-group of from 1 to 20 atoms, not counting hydrogen.

More preferably,

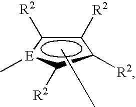

each occurrence is 3-(N-pyrrolyl)indene-1-yl, 3-(N,N-dimethylamino)indene-1-yl, 3-(N-3,4-benzopyrrolyl)indene-1-yl, 2-methyl-4-phenylindene-1-yl, 2-methyl4-(2-methylphenyl)indene-1-yl, 2-methyl4-(3,5-dimethylphenyl)indene-1-yl, or 2-methyl-4-naphthylindene-1-yl.

More preferably in the previously disclosed formulas:

M is zirconium or titanium;

Z is boron;

T independently each occurrence is C₁₋₄ alkyl, or phenyl, more preferably phenyl;

T′⁺, is trimethylphosphoniummethyleneylide, triphenylphosphoniummethyleneylide, or T—T′⁺ together is: —C₆H₄—P(R¹)═N⁺(R¹)—;

Y¹ and Y² are both inden-1-yl, 2-methyl-4-phenylinden-1-yl, or 2-methyl-4-(3,5-dimethylphenyl)inden-1-yl, or Y¹ is cyclopentadienyl or C₁₋₁₀ alkyl-substituted cyclopentadienyl and Y² is fluorenyl; Z is boron; and

Q is halide, C₁₋₁₀ alkyl, N,N-di(C₁₋₁₀ alkyl)amido, or 1,4-diphenyl-1,3-butadiene.

Even more preferably in formulas 4a-c and 7a-c, M is zirconium, Z is boron; and T is phenyl.

Even more preferably in formulas 5a-c, 6a-c, 8a-c and 9a-c, M is titanium, Z is boron, and R¹ is C₁₋₄ allyl or phenyl, most preferably methyl or isopropyl.

Most highly preferred metal complexes are those of formulas 4a-c and 7a-c wherein Y¹ and Y² are both inden-1-yl, 2-methyl-4-phenylinden-1-yl, 3-isopropylinden-1-yl, or 3-t-butylinden-1-yl groups, especially compositions comprising greater than 90 percent rac-isomer.

In general the complexes of the current invention can be prepared by first converting the ligands represented in formulas 1a, 1b and 2a to a dianionic salt (where J is H) via reaction with a metal amide such as an alkali metal-bis(trimethylsilyl)amide. The dianionic ligand derivative is then reacted with a metal complex precursor such as MY³₄, MY³₃, or MY³₂ (and the corresponding Lewis base adducts), where Y³ is defined as above. Alternatively, reactions employing the neutral ligand, where J is hydrogen, in combination with the metal precursors M(NR³₂)₄ or MR³₄ can be employed. All of the foregoing reactions are conducted in an inert solvent such as an aliphatic or aromatic hydrocarbon solvent in the temperature range of −100° C. to 150° C.

An especially useful metal complex precursor reagent corresponds to the formula 3:

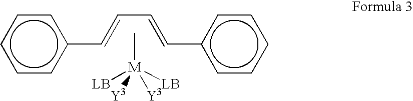

wherein M is zirconium or hafnium, R¹ and LB are as previously defined and Y³ each occurrence is chloride. Employment of this precursor in the reaction with ligands of this invention renders the resulting metal complex in high racemic purity, which is especially useful in the stereospecific polymerization of α-olefins having 3 or more carbons.

Alternatively, where J in structures of formula 1a, 1b and 2a is a trimethyltin- or trimethylsilyl- group the ligand can be reacted directly with any of the above metal complex precursors of formula 3, employing similar reaction conditions.

The recovery of the desired Group 4 transition metal complex is accomplished by separation of the product from any alkali metal or alkaline earth metal salts and devolatilization of the reaction medium. Extraction into a secondary solvent may be employed if desired. Alternatively, if the desired product is an insoluble precipitate, filtration or other separation techniques may be employed. Final purification, if required, may be accomplished by recrystallization from an inert solvent, employing low temperatures if needed.

The complexes may be rendered catalytically active by combination with an acitvating cocatalyst. Suitable activating cocatalysts for use herein include polymeric or oligomeric alumoxanes, especially methylalumoxane, triisobutyl aluminum modified methylalumoxane, or isobutylalumoxane; neutral Lewis acid modified polymeric or oligomeric alumoxanes, such as the foregoing alkylalumoxanes modified by addition of a C₁₋₃₀ hydrocarbyl substituted Group 13 compound, especially a tri(hydrocarbyl)aluminum- or tri(hydrocarbyl)boron compound, or a halogenated (including perhalogenated) derivative thereof, having from 1 to 10 carbons in each hydrocarbyl or halogenated hydrocarbyl group, more especially a perfluorinated tri(aryl)boron compound or a perfluorinated tri(aryl)aluminum compound. Surprisingly, other known polymerization cocatalysts for metallocene compounds, and most especially trispentafluorophenyl)borane, nonpolymeric, compatible, noncoordinating, ion forming compounds, especially ammonium-, phosphonium-, oxonium-, carbonium-, silylium- or sulfonium-salts of compatible, noncoordinating anions, or ferrocenium salts of compatible, noncoordinating anions are ineffective cocatalysts for use with the present metal complexes.

The molar ratio of metal complex/cocatalyst employed preferably ranges from 1:10,000 to 1:1, more preferably from 1:5000 to 1:10, most preferably from 1:1000 to 1:10. When a combination of a neutral Lewis acid and an alumoxane is employed, especially the combination of a tris(pentafluorophenyl)borane with a polymeric or oligomeric alumoxane is employed, the molar ratio of metal complex:Lewis acid:alumoxane is preferably from 1:1:1 to 1:10:1000, more preferably from 1:1:1.5 to 1:5:100.

Although not a preferred embodiment, the complexes may also be rendered catalytically active by combination with a cation forming cocatalyst such as those previously known in the art for use with Group 4 metal olefin polymerization complexes. Examples of such cation forming cocatalysts include neutral Lewis acids, such as C₁₋₃₀ hydrocarbyl substituted Group 13 compounds, especially tri(hydrocarbyl)aluminum- or triohydrocarbyl)boron compounds and halogenated (including perhalogenated) derivatives thereof, having from 1 to 10 carbons in each hydrocarbyl or halogenated hydrocarbyl group, more especially perfluorinated tri(aryl)boron compounds, and most especially tris(pentafluoro-phenyl)borane; nonpolymeric, compatible, noncoordinating, ion forming compounds (including the use of such compounds under oxidizing conditions), especially the use of ammonium-, phosphonium-, oxonium-, carbonium-, silylium- or sulfonium- salts of compatible, noncoordinating anions, or ferrocenium salts of compatible, noncoordinating anions; and combinations of the foregoing cation forming cocatalysts and techniques. The foregoing activating cocatalysts and activating techniques have been previously taught with respect to different metal complexes in the following references: EP-A-277,003, U.S. Pat. No. 5,153,157, U.S. Pat. No. 5,064,802, U.S. Pat. No. 5,321,106, U.S. Pat. No. 5,721,185, U.S. Pat. No. 5,350,723, U.S. Pat. No. 5,425,872, U.S. Pat. No. 5,625,087, U.S. Pat. No. 5,883,204, U.S. Pat. No. 5,919,983, U.S. Pat. No. 5,783,512, WO 99/15534, WO99/42467, (equivalent to U.S. Ser. No. 09/251,664, filed Feb. 17, 1999).

Examples of cation forming cocatalysts include compounds comprising a cation that is a Brønsted acid capable of donating a proton, and a compatible, noncoordinating anion, A⁻. As used herein, the term “noncoordinating” means an anion or substance which either does not coordinate to the metal complex or the catalytic derivative derived therefrom, or which is only weakly coordinated to such complexes thereby remaining sufficiently labile to be displaced by a neutral Lewis base. A noncoordinating anion specifically refers to an anion which when functioning as a charge balancing anion in a cationic metal complex does not transfer an anionic substituent or fragment thereof to said cation thereby forming neutral complexes. “Compatible anions” are anions which are not degraded to neutrality when the initially formed complex decomposes and are noninterfering with desired subsequent polymerization or other uses of the complex.

Preferred anions are those containing a single coordination complex comprising a charge-bearing metal or metalloid core which anion is capable of balancing the charge of the active catalyst species (the metal cation) which may be formed when the two components are combined. Also, said anion should be sufficiently labile to be displaced by olefinic, diolefinic and acetylenically unsaturated compounds or other neutral Lewis bases such as ethers or nitrites. Suitable metals include, but are not limited to, aluminum, gold and platinum. Suitable metalloids include, but are not limited to, boron, phosphorus, and silicon. Compounds containing anions which comprise coordination complexes containing a single metal or metalloid atom are, of course, well known and many, particularly such compounds containing a single boron atom in the anion portion, are available commercially.

Preferably such cocatalysts may be represented by the following general formula:

(L-H)_{d}⁺(A)^{d-},

wherein:

L* is a neutral Lewis base;

(L*-H)⁺ is a conjugate Brønsted acid of L*;

A^{d-} is a noncoordinating, compatible anion having a charge of d−, and

d is an integer from 1 to 3.

More preferably, A^{d-} corresponds to the formula: [M′Q₄]⁻; wherein:

M′ is boron or aluminum in the +3 formal oxidation state; and

Q independently each occurrence is selected from hydride, dialkylamido, halide, hydrocarbyl, hydrocarbyloxide, halo-substituted hydrocarbyl, halo-substituted hydrocarbyloxy, and halo-substituted silylhydrocarbyl radicals (including perhalogenated hydrocarbyl-perhalogenated hydrocarbyloxy- and perhalogenated silylhydrocarbyl radicals), said Q having up to 20 carbons with the proviso that in not more than one occurrence is Q halide. Examples of suitable hydrocarbyloxide Q groups are disclosed in U.S. Pat. No. 5,296,433.

In a more preferred embodiment, d is one, that is, the counter ion has a single negative charge and is A⁻. Activating cocatalysts comprising boron which are particularly useful in the preparation of catalysts of this invention may be represented by the following general formula:

(L*-H)⁺(BQ₄)⁻;

wherein:

L* is as previously defined;

B is boron in a formal oxidation state of 3; and

Q is a hydrocarbyl-, hydrocarbyloxy-, fluorohydrocarbyl-, fluorohydrocarbyloxy-, hydroxyfluorohydrocarbyl-, dihydrocarbylaluminumoxyfluorohydrocarbyl-, or fluorinated silylhydrocarbyl-group of up to 20 nonhydrogen atoms, with the proviso that in not more than one occasion is Q hydrocarbyl.

Preferred Lewis base salts are ammonium salts, more preferably trialkylammonium salts containing one or more C₁₂₋₄₀ alkyl groups. Most preferably, Q is each occurrence a fluorinated aryl group, especially, a pentafluorophenyl group.

Illustrative, but not limiting, examples of boron containing cation forming cocatalysts are

tri-substituted ammonium salts such as:

trimethylammonium tetrakis(pentafluorophenyl)borate,

triethylammonium tetrakis(pentafluorophenyl)borate,

tripropylammonium tetrakis(pentafluorophenyl)borate,

tri(n-butyl)ammonium tetrakis(pentafluorophenyl)borate,

tri(sec-butyl)ammonium tetakis(pentafluorophenyl)borate,

N,N-dimnethylanilinium tetrakis(pentafluorophenyl)borate,

N,N-diethylanilinium n-butyltris(pentafluorophenyl)borate,

N,N-dimethylanilinium benyltris(pentafluorophenyl)borate,

N,N-dimethylanilinium tetrakis(4-(t-butyldimethylsilyl)-2,3,5,6-tetrafluorophenyl)borate,

N,N-dimethylaniinium tetrakis(4triisopropylsilyl)-2,3,5,6-tetrafluorophenyl)borate,

N,N-dimethylanilinium pentafluorophenoxytris(pentafluorophenyl)borate,

N,N-diethylanilinium tetrakis(pentafluorophenyl)borate,

N,N-dimethyl-2,4,6-trimethylanilinium tetrakis(pentafluorophenyl)borate,

dimethyltetradecylammonium tetrakis(pentafluorophenyl)borate,

dimethylhexadecylammonium tetrakis(pentafluorophenyl)borate,

dimethyloctadecylammonium tetrakis(pentafluorophenyl)borate,

methylditetradecylammonium tetrakis(pentafluorophenyl)borate,

methylditetradecylammonium(hydroxyphenyl)tris(pentafluorophenyl)borate,

methylditetradecylammonium(diethylaluminoxyphenyl)tris(pentafluorophenyl)borate,

methyldihexadecylammonium tetrakis(pentafluorophenyl)borate,

methyldihexadecylammonium(hydroxyphenyl)tris(pentafluorophenyl)borate,

methyldihexadecylammonium(diethylaluminoxyphenyl)tris(pentafluorophenyl)borate,

methyldioctadecylammonium tetrakis(pentafluorophenyl)borate,

methyldioctadecylammonium(hydroxyphenyl)tris(pentafluorophenyl)borate,

methyldioctadecylammonium(diethylaluminoxyphenyl)tris(pentafluorophenyl)borate,

mixtures of the foregoing,

dialkyl ammonium salts such as:

di-(i-propyl)ammonium tetrakis(pentafluorophenyl)borate,

methyloctadecylammonium tetrakis(pentafluorophenyl)borate,

methyloctadodecylammonium tetrakis(pentafluorophenyl)borate, and

dioctadecylammonium tetrakis(pentafluorophenyl)borate;

tri-substituted phosphonium salts such as:

triphenylphosphonium tetrakis(pentafluorophenyl)borate,

methyldioctadecylphosphonium tetrakis(pentafluorophenyl)borate, and

tri(2,6-dimethylphenyl)phosphonium tetrakis(pentafluorophenyl)borate;

di-substituted oxonium salts such as:

diphenyloxonium tetrakis(pentafluorophenyl)borate,

di(o-tolyl)oxonium tetrakis(pentafluorophenyl)borate, and

di(octadecyl)oxonium tetrakis(pentafluorophenyl)borate;

di-substituted sulfonium salts such as:

di(o-tolyl)sulfonium tetrakis(pentafluorophenyl)borate, and

methylcotadecylsulfonium tetrakis(pentafluorophenyl)borate.

Preferred (L*-H)⁺ cations are methyldioctadecylammonium and dimethyloctadecylammonium.

Another cation forming, activating cocatalyst comprises a salt of a cationic oxidizing agent and a noncoordinating, compatible anion represented by the formula:

(Ox^{e+})_{d}(A^{d-})ₑ.

wherein:

Ox^{e+} is a cationic oxidizing agent having a charge of e+;

e is an integer from 1 to 3; and

A^{d-} and d are as previously defined.

Examples of cationic oxidizing agents include: ferrocenium, hydrocarbyl-substituted ferrocenium, Ag^{+,} or Pb⁺². Preferred embodiments of A^{d-} are those anions previously defined with respect to the Bronsted acid containing activating cocatalysts, especially tetrakis(pentafluorophenyl)borate.

Another cation forming, activating cocatalyst comprises a compound which is a salt of a carbenium ion and a noncoordinating, compatible anion represented by the formula:

©⁺A⁻

wherein:

©⁺ is a C₁₋₂₀ carbenium ion; and

A⁻ is as previously defined. A preferred carbenium ion is the trityl cation, that is triphenylmethylium.

A further cation forming, activating cocatalyst comprises a compound which is a salt of a silylium ion and a noncoordinating, compatible anion represented by the formula:

R₃Si(X′)_{q}⁺A⁻

wherein:

R is C₁₋₁₀ hydrocarbyl, and X′, q and A⁻ are as previously defined.

Preferred silylium salt activating cocatalysts are trimethylsilylium tetrakispentafluorophenylborate, triethylsilylium tetrakispentafluorophenylborate and ether substituted adducts thereof. Silylium salts have been previously generically disclosed in J. Chem Soc. Chem. Comm., 1993, 383-384, as well as Lambert, J. B., et al., Organometallics, 1994, 13, 2430-2443. The use of the above silylium salts as activating cocatalysts for addition polymerization catalysts is disclosed in U.S. Ser. No. 304,314, filed Sep. 12, 1994, published in equivalent form as WO96/08519 on Mar. 21, 1996.

Certain complexes of alcohols, mercaptans, silanols, and oximes with tris(pentafluorophenyl)borane are also known catalyst activators. Such cocatalysts are disclosed in U.S. Pat. No. 5,296,433.

Another class of cation forming cocatalyst activators are expanded anionic compounds corresponding to the formula: (A^{1+a}^{¹})_{b}1(Z¹J¹ⱼ1)^{-c1}_{d}1,

wherein:

A¹ is a cation of charge +a¹,

Z¹ is an anion group of from 1 to 50, preferably 1 to 30 atoms, not counting hydrogen atoms, further containing two or more Lewis base sites;

J¹ independently each occurrence is a Lewis acid coordinated to at least one Lewis base site of Z¹, and optionally two or more such J¹ groups may be joined together in a moiety having multiple Lewis acidic functionality,

j¹ is a number from 2 to 12 and

a¹, b¹, c¹, and d¹ are integers from 1 to 3, with the proviso that a¹×b¹ is equal to c¹×d¹.

The foregoing cocatalysts (illustrated by those having imidazolide, substituted imidazolide, imidazolinide, substituted imidazolinide, benzimidazolide, or substituted benzimidazolide anions) may be depicted schematically as follows:

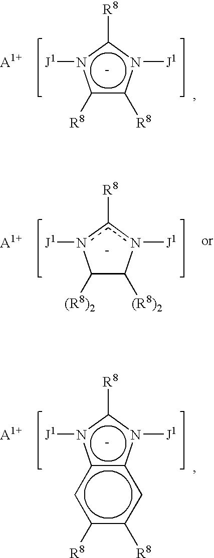

wherein:

A¹⁺ is a monovalent cation as previously defined, and preferably is a trihydrocarbyl ammonium cation, containing one or two C₁₀₋₄₀ alkyl groups, especially the methylbis(tetradecyl)ammonium- or methylbis(octadecyl)ammonium-cation,

R⁸, independently each occurence, is hydrogen or a halo, hydrocarbyl, halocarbyl, halohydrocarbyl, silylhydrocarbyl, or silyl, (including mono-, di- and tri(hydrocarbyl)silyl) group of up to 30 atoms not counting hydrogen, preferably C₁₋₂₀ alkyl, and

J¹ is tris(pentafluorophenyl)borane or tris(pentafluorophenyl)aluminane.

Examples of these catalyst activators include the trihydrocarbylammonium-, especially, methylbis(tetradecyl)ammonium- or methylbis(octadecyl)ammonium-salts of: bis(tris(pentafluorophenyl)borane)imidazolide, bis(tris(pentafluorophenyl)borane)2-undecylimidazolide, bis(tris(pentafluorophenyl)borane)-2-heptadecylimidazolide, bis(tris(pentafluorophenyl)borane)-4,5-bis(undecyl)imidazolide, bis(tris(pentafluorophenyl)borane)4,5-bis(heptadecyl)imidazolide, bis(tris(pentafluorophenyl)borane)imidazolinide, bis(tris(pentafluorophenyl)borane)-2-undecylimidazolinide, bis(tris(pentafluorophenyl)borane)-2-heptadecylimidazolinide, bis(tris(pentafluorophenyl)borane)-4,5-bis(undecyl)imidazolinide, bis(tris(pentafluorophenyl)borane)-4,5-bis(heptadecyl)imidazolinide, bis(tris(pentafluorophenyl)borane)-5,6 dimethylbenzimidazolide, bis(tris(pentafluorophenyl)borane)-5,6-bis(undecyl)benzimidazolide, bis(tris(pentafluorophenyl)alumane)imidazolide, bis(tris(pentafluorophenyl)alumane)-2-undecylimidazolide, bis(tris(pentafluorophenyl)alumane)-2-heptadecylimidazolide, bis(tris(pentafluorophenyl)alumane)-4,5-bis(undecyl)imidazolide, bis(tris(pentafluorophenyl)alumane)-4,5-bis(heptadecyl)imidazolide, bis(tris(pentafluorophenyl)alumane)imidazolinide, bis(tris(pentafluorophenyl)alumane)-2-undecylimidazolinide, bis(trisepentafluorophenyl)alumane)-2-heptadecylimidazolinide, bis(tris(pentafluorophenyl)alumane)-4,5-bis(undecyl)imidazolinide, bis(tris(pentafluorophenyl)alumane)-4,5-bistheptadecyl)imidazolinide, bis(tris(pentafluorophenyl)alumane)-5,6-dimethylbenzimidazolide, and bis(tris(pentafluorophenyl)alumane)-5,6-bis(undecyl)benzimidazolide.

Finally, strong Lewis acids such as tris(pentafluorophenyl)borane or tris(pentafluorophenyl)alumane, and mixtures thereof or with an alkylaluminum compound, especially the combination of a trialkylaluminum compound having from 1 to 4 carbons in each alkyl group and a halogenated tri(hydrocarbyl)boron compound having from 1 to 20 carbons in each hydrocarbyl group, especially tris(pentafluorophenyl)borane, are suitable cation forming activating cocatalysts as well.

A support, especially silica, alumina, clay, or a polymer (especially poly(tetrafluoroethylene) or a polyolefin) may be employed, and desirably is employed when the catalysts are used in a gas phase or slurry polymerization process. The support is preferably employed in an amount to provide a weight ratio of catalyst (based on metal):support from 1:100,000 to 1:l0, more preferably from 1:50,000 to 1:20, and most preferably from 1:10,000 to 1:30.

The catalyst compositions, whether or not supported in any of the foregoing methods, may be used to polymerize ethylenically and/or acetylenically unsaturated monomers having from 2 to 100,000 carbon atoms either alone or in combination. Preferred monomers include the C₂₋₂₀ α-olefins especially ethylene, propylene, isobutylene, 1-butene, 1-pentene, 1-hexene, 3-methyl-1-pentene, 4-methyl-1-pentene, 1-octene, 1-decene, long chain macromolecular α-olefins, and mixtures thereof. Other preferred monomers include styrene, C₁₋₄ alkyl substituted styrene, tetrafluoroethylene, vinylbenzocyclobutane, ethylidenenorbornene, 1,4-hexadiene, 1,7-octadiene, vinylcyclohexane, 4-vinylcyclohexene, divinylbenzene, and mixtures thereof with ethylene. Long chain macromolecular a-olefins are vinyl terminated polymeric remnants formed in situ during continuous solution polymerization reactions. Under suitable processing conditions such long chain macromolecular units are readily polymerized into the polymer product along with ethylene and other short chain olefin monomers to give small quantities of long chain branching in the resulting polymer.

Preferred monomers include a combination of ethylene and one or more comonomers selected from monovinyl aromatic monomers, 4-vinylcyclohexene, vinylcyclohexane, norbornadiene, ethylidene-norbomene, C₃₋₁₀ aliphatic α-olefins (especially propylene, isobutylene, 1-butene, 1-hexene, 3-methyl-1-pentene, 4-methyl-1-pentene, and 1-octene), and C₄₋₄₀ dienes. Most preferred monomers are mixtures of ethylene and styrene; mixtures of ethylene, propylene and styrene; mixtures of ethylene, styrene and a nonconjugated diene, especially ethylidenenorbornene or 1,4-hexadiene, and mixtures of ethylene, propylene and a nonconjugated diene, especially ethylidenenorbornene or 1,4-hexadiene.

In general, the polymerization may be accomplished at conditions well known in the prior art for Ziegler-Natta or Kaminsky-Sinn type polymerization reactions, that is, temperatures from 0-250° C., preferably 30 to 200° C. and pressures from atmospheric to 10,000 atmospheres. Suspension, solution, slurry, gas phase, solid state powder polymerization or other process condition may be employed if desired. In most polymerization reactions the molar ratio of catalyst-polymerizable compounds employed is from 10⁻¹²:1 to 10⁻¹:1, more preferably from 10⁻⁹:1 to 10⁻⁵:1.

Suitable solvents use for solution polymerization are inert liquids. Examples include straight and branched-chain hydrocarbons such as isobutane, butane, pentane, hexane, heptane, octane, and mixtures thereof; cyclic and alicyclic hydrocarbons such as cyclohexane, cycloheptane, methylcyclohexane, methylcycloheptane, and mixtures thereof; perfluorinated hydrocarbons such as perfluorinated C₄₋₁₀ alkanes, and alkyl-substituted aromatic compounds such as benzene, toluene, xylene, and ethylbenzene. Suitable solvents also include liquid olefins which may act as monomers or comonomers.

The catalysts may be utilized in combination with at least one additional homogeneous or heterogeneous polymerization catalyst in the same reactor or in separate reactors connected in series or in parallel to prepare polymer blends having desirable properties. Utilizing the present catalysts, α-olefin homopolymers and copolymers having densities from 0.85 g/cm³ to 0.96 g/cm³, and melt flow rates from 0.001 to 1000.0 dg/min are readily attained in a highly efficient process.

The catalysts of the present invention are particularly advantageous for the production of ethylene homopolymers and ethylene/a-olefin copolymers having high levels of long chain branching. The use of the catalysts of the present invention in continuous polymerization processes, especially continuous, solution polymerization processes, allows for elevated reactor temperatures which favor the formation of vinyl terminated polymer chains that may be incorporated into a growing polymer, thereby giving a long chain branch. The use of the present catalyst compositions advantageously allows for the economical production of ethylene/α-olefin copolymers having processability similar to high pressure, free radical produced low density polyethylene.

The present catalyst compositions may be advantageously employed to prepare olefin polymers having improved processing properties by polymerizing ethylene alone or ethylene/α-olefin mixtures with low levels of a “H” branch inducing diene, such as norbornadiene, 1,7-octadiene, or 1,9-decadiene. The unique combination of elevated reactor temperatures, high molecular weight (or low melt indices) at high reactor temperatures and high comonomer reactivity advantageously allows for the economical production of polymers having excellent physical properties and processability. Preferably such polymers comprise ethylene, a C₃₋₂₀ α-olefin and a “H”-branching comonomer. Preferably, such polymers are produced in a solution process, most preferably a continuous solution process.

The catalyst composition may be prepared as a homogeneous catalyst by addition of the requisite components to a solvent or diluent in which polymerization will be conducted. The catalyst composition may also be prepared and employed as a heterogeneous catalyst by adsorbing, depositing or chemically attaching the requisite components on an inert inorganic or organic particulated solid. Examples of such solids include, silica, silica gel, alumina, clays, expanded clays (aerogels), aluminosilicates, trialkylaluminum compounds, and organic or inorganic polymeric materials, especially polyolefins. In an preferred embodiment, a heterogeneous catalyst is prepared by reacting an inorganic compound, preferably a tri(C₁₋₄ alkyl aluminum compound, with an activating cocatalyst, especially an ammonium salt of a hydroxyaryl(trispentafluoro-phenyl)borate, such as an ammonium salt of (4hydroxy-3,5-ditertiarybutylphenyl)tris-(pentafluorophenyl)borate or (4hydroxyphenyl)-tris(pentafluorophenyl)borate. This activating cocatalyst is deposited onto the support by coprecipitating, imbibing, spraying, or similar technique, and thereafter removing any solvent or diluent. The metal complex is added to the support, also by adsorbing, depositing or chemically attaching the same to the support, either subsequently, simultaneously or prior to addition of the activating cocatalyst.

When prepared in heterogeneous or supported form, the catalyst composition is employed in a slurry or gas phase polymerization. As a practical limitation, slurry polymerization takes place in liquid diluents in which the polymer product is substantially insoluble. Preferably, the diluent for slurry polymerization is one or more hydrocarbons with less than 5 carbon atoms. If desired, saturated hydrocarbons such as ethane, propane or butane may be used in whole or part as the diluent Likewise the α-olefin monomer or a mixture of different α-olefin monomers may be used in whole or part as the diluent. Most preferably at least a major part of the diluent comprises the α-olefin monomer or monomers to be polymerized.

At all times, the individual ingredients as well as the recovered catalyst components must be protected from oxygen and moisture. Therefore, the catalyst components and catalysts must be prepared and recovered in an oxygen and moisture free atmosphere. Preferably, therefore, the reactions are performed in the presence of a dry, inert gas such as, for example, nitrogen.

The polymerization may be carried out as a batchwise or a continuous polymerization process. A continuous process is preferred, in which event catalyst, ethylene, comonomer, and optionally solvent are continuously supplied to the reaction zone and polymer product continuously removed therefrom.

Without limiting in any way the scope of the invention, one means for carrying out such a polymerization process is as follows. In a stirred-tank reactor, the monomers to be polymerized are introduced continuously together with solvent and an optional chain transfer agent. The reactor contains a liquid phase composed substantially of monomers together with any solvent or additional diluent and dissolved polymer. If desired, a small amount of a “H”-branch inducing diene such as norbomadiene, 1,7-octadiene or 1,9-decadiene may also be added. Catalyst and cocatalyst are continuously introduced in the reactor liquid phase. The reactor temperature and pressure may be controlled by adjusting the solvent/monomer ratio, the catalyst addition rate, as well as by cooling or heating coils, jackets or both. The polymerization rate is controlled by the rate of catalyst addition. The ethylene content of the polymer product is determined by the ratio of ethylene to comonomer in the reactor, which is controlled by manipulating the respective feed rates of these components to the reactor. The polymer product molecular weight is controlled, optionally, by controlling other polymerization variables such as the temperature, monomer concentration, or by the previously mention chain transfer agent, such as a stream of hydrogen introduced to the reactor, as is well known in the art The reactor effluent is contacted with a catalyst kill agent such as water. The polymer solution is optionally heated, and the polymer product is recovered by flashing off gaseous monomers as well as residual solvent or diluent at reduced pressure, and, if necessary, conducting further devolatilization in equipment such as a devolatilizing extruder. In a continuous process the mean residence time of the catalyst and polymer in the reactor generally is from about 5 minutes to 8 hours, and preferably from 10 minutes to 6 hours. By using a catalyst that incorporates large amounts of hindered monovinyl monomer, hindered monovinyl homopolymer formed from residual quantities of the monomer are substantially reduced.

Ethylene homopolymers and ethylene/α-olefin copolymers are particularly suited for preparation according to the invention. Generally such polymers have densities from 0.88 to 0.96 g/ml. Typically the molar ratio of α-olefin comonomer to ethylene used in the polymerization may be varied in order to adjust the density of the resulting polymer. When producing materials with a density range of from 0.91 to 0.93 the comonomer to monomer ratio is less than 0.2, preferably less than 0.05, even more preferably less than 0.02, and may even be less than 0.01. In the above polymerization process hydrogen has been found to effectively control the molecular weight of the resulting polymer. Typically, the molar ratio of hydrogen to monomer is less than about 0.5, preferably less than 0.2, more preferably less than 0.05, even more preferably less than 0.02 and may even be less than 0.01.

### EXAMPLES

The skilled artisan will appreciate that the invention disclosed herein may be practiced in the absence of any component which has not been specifically disclosed. The following examples are provided as further illustration of the invention and are not to be construed as limiting. Unless stated to the contrary all parts and percentages are expressed on a weight basis. The term “overnight”, if used, refers to a time of approximately 16-18 hours, the term “room temperature”, refers to a temperature of about 20-25° C., and the term “mixed alkanes” refers to a commercially obtained mixture of C₆₋₉ aliphatic hydrocarbons available under the trade designation Isopar E®, from Exxon Chemicals Inc. In the event the name of a compound herein does not conform to the structural representation thereof, the structural representation shall control.

¹H (300 MHz) and ¹³C NMR (75 MHz) spectra were recorded on a Varian XL-300 spectrometer. ¹H and ¹³C NMR spectra are referenced to the residual solvent peaks and are reported in ppm relative to tetramethylsilane. All J values are given in Hz. Tetrahydrofuran (THF), diethylether, toluene, and hexane were used following passage through double columns charged with activated alumina and a purifying catalyst (Q-5® available from Englehardt Chemicals Inc.) The compounds BCl₃—SMe₂, BBr₃—SMe₂, B(NMe₂)₃, n-BuLi were all used as purchased from Aldrich. The compound TiCl₃(THF)₃ was prepared as described in the literature. All syntheses were performed under dry nitrogen or argon atmospheres using a combination of glove box and high vacuum techniques.

### Example 1

(triphenylphosphoniummethylide)phenylborano bis(cyclopentadienyl) zirconium dichloride

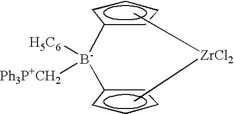

Toluene (50 mL) was added to a glass flask containing dimethylsulfidophenylboron bis(cyclopentadienyl)zirconium dichloride ({(CH₃)₂S)(C₆H₅)B(C₅H₄)₂}ZrCl₂, 0.503 g, 1.00 mmol) (prepared according to Organometallics, 16, p4546-4550 (1997)) and methylenetriphenylphosphine ((C₆H₅)₃PCH₂, 0.285 g, 1.03 mmol) and the resulting mixture was stirred overnight at room temperature. The resulting yellow-green precipitate was collected by filtration and dried under reduced pressure. Yield was 0.605 g, 85 percent.

### Example 2

(triphenylphosphoniummethylide)phenylborano bis(cyclopentadienyl) zirconium bis(trimethylsilylmethyl)

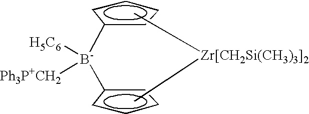

Toluene (30 mL) was added to a glass flask containing the metal complex of Example 1 (0.491 g, 0.751 mmol) and trimethylsilylmethyllithium (0.151 g, 1.60 mmol) and the mixture was stirred overnight at room temperature. The reaction mixture was filtered to remove LiCl and the toluene was removed under reduced pressure and replaced with petroleum ether, from which the product was crystallized at −78° C. as a yellow-gray solid. Yield was 0.050 g, 0.066 mmol, 9 percent.

### Example 3

(triphenylphosphoniummethylide)phenylborano bis(2-methyl-4-phenylindenyl) zirconium dichloride

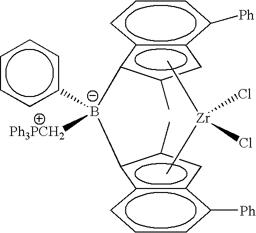

A) Preparation of Bis(2-methyl-4-phenylindenyl)phenylborane.

A solution of phenyllithium (1.8 M solution in cyclohexane-ether, 0.639 mL, 1.15 mmoL) is added to a solution of bis(2-methyl4-phenylindenyl)bromoborane (1.00 g, 2.30 mmoL) in diethylether (50 mL) at −78° C. This solution is then allowed to stir overnight at room temperature. After the reaction period the volatiles are removed under vacum and the residue extracted resulting in the isolation of the desired product as a dark residue (0.575 g, 78.9 percent yield).

B) Preparation of Bis(2-methyl4-phenylindenyl)phenylboranezirconiumdichloride, methylenetriphenylphosphine salt.

Solid lithium bis(trimethylsilyl)amide (0.201 g, 1.20 mmoL) is added to a solution of bis(2-methyl-4-phenylindenyl)phenylborane (0.300 g, 0.600 mmoL) in THF (30 mL). This mixture is allowed to stir overnight. Solid zirconiumtetrachloride (0.140 g, 0.600 mmoL) is then added followed by methylenetriphenylphosphine (0.166 g, 0.600 mmoL) and the resulting mixture allowed to stir overnight. After the reaction period the mixture is filtered and the volatiles removed resulting in the isolation of an orange solid which is washed well with hexane and dried under vacuum (0.343 g, 61.2 percent yield).

### Example 4

(trimethylphosphoniummethylide)phenylborano bis(2-methyl-4-phenylindenyl) zirconium dichloride

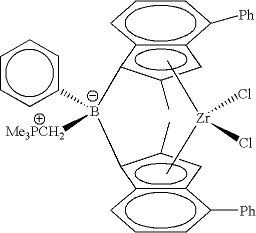

The reaction conditions of Example 3B) were substantially repeated using methylenetnimethylphosphine (0.054 g, 0.600 mmoL) in place of methylenetriphenylphosphine. The desired product (0.3 g, 60 percent yield) was recovered after devolatilization.

Solution Ethylene/1-octene Copolymerization

Batch reactor polymerizations were conducted in a two liter Parr reactor equipped with an electrical heating jacket, internal serpentine coil for cooling, and a bottom drain valve. Pressures, temperatures and block valves were computer monitored and controlled. Mixed alkanes solvent (about 740 g) and 1-octene (118 g) were measured in a solvent shot tank fitted with a differential pressure transducer or weigh cell. These liquids were then added to the reactor from the solvent shot tank The contents of the reactor were stirred at 1200 rpm. Hydrogen was added by differential expansion (Δ25 psi, 170 kPa) from a 75 ml shot tank initially at 300 psig (2.1 Mpa). The contents of the reactor was then heated to the desired run temperature under 500 psig (3.4 Mpa) of ethylene pressure. The catalyst composition (as a 0.0050 M solution in toluene) and cocatalyst were combined in the desired ratio in the glove box and transferred from the glove box to the catalyst shot tank through 1/16 in (0.16 cm) tubing using toluene to aid in the transfer. The catalyst tank was then pressurized to 700 psig (4.8 Mpa) using nitrogen. After the contents of the reactor had stabilized at the desired run temperature of 140° C., the catalyst was injected into the reactor via a dip tube. The temperature was maintained by allowing cold ethylene glycol to pass through the internal cooling coils. The reaction was allowed to proceed for 15 minutes with ethylene provided on demand. Additional injections of catalyst composition prepared and injected in the same manner were employed where indicated. The contents of the reactor were then expelled into a 4 liter nitrogen purged vessel and quenched with isopropyl alcohol. Approximately 10 ml of a toluene solution containing approximately 67 mg of a hindered phenol antioxidant (Irganox™ 1010 from Ciba Geigy Corporation) and 133 mg of a phosphorus stabilizer (Irgafos™ 168 from Ciba Geigy Corporation) were added. Volatile materials were removed from the polymers in a vacuum oven that gradually heated the polymer to 140° C. overnight and cooled to at least 50° C. prior to removal from the oven. After completion of the polymerization, the reactor was washed with 1200 ml of mixed hexanes solvent at 150° C. before reuse. Results are contained in Table 1.

TABLE 1

| | | | Catalyst/ | | Den- | | |
|---|---|---|---|---|---|---|---|
| | Cata- | cocata- | cocatalyst | Efficiency | sity* | | |
| Run | lyst | lyst | (μmoles) | (g/μg Zr) | g/ml | Mn | Mw/Mn |
| 1 | Ex. 1 | MAO¹ | 1/1000 | 7.8 | — | 7,500 | 2.3 |
| 2 | Ex. 2 | ″ | 1/200 | 3.4 | 0.948 | — | — |
| 3 | ″ | ″ | 1/500 | 2.8 | 0.951 | — | — |
| 4 | ″ | FAAL² | 1/4 | 0.01 | — | — | — |
| 5 | ″ | ″ | 1/8 | 0.01 | — | — | — |
| 6 | Ex. 3 | MAO | 1/1000 | 7.7 | — | — | — |
| 7 | Ex. 4 | ″ | 1/1000 | 0.08 | — | — | — |

^{1.}methylalumoxane
^{2.}tris(pentafluorophenyl)aluminum

Propylene Polymerization

Batch reactor polymerizations were conducted in a two liter Zipperclave reactor equipped with water circulating (used for the 70 and 85° C. polymerizations) or steam heating (used for higher temperature polymerizations) and a bottom drain valve. Pressures, temperatures and block valves were computer monitored and controlled Solvent (Isopar E, available from Exxon Chemicals, Inc., 625 g) and propylene (150 g) were measured in a solvent shot tank fitted with a micromotion addition system. These liquids were then added to the reactor from the solvent shot tank. The contents of the reactor were stirred at 1000 rpm. Hydrogen was added by differential expansion (Δ17 or 25 psi, Δ120 or 170 kPa) from a 75 mL shot tank initially at 250 psig (1.7 MPa). The contents of the reactor was then heated to the desired run temperature. The catalyst (example 3) and MAO cocatalyst (as a 0.0050 M solution in toluene) were combined in molar ratio of 1/1000 in the glove box and transferred from the glove box to the catalyst shot tank through 1/16 in (0.16 cm) tubing using toluene to aid in the transfer. The catalyst tank was then pressurized to approximately 600 psig (4.1 MPa) using nitrogen. After the contents of the reactor had stabilized at the desired run temperature, the catalyst was injected into the reactor via a dip tube. The temperature was maintained throughout the run, with typical exotherms of 1 to 3° C. being observed. The run time, which was recorded, varied from run to run (5 to 30 minutes depending on activity). Additional injections of catalyst composition prepared and injected in the same manner were employed where indicated. The contents of the reactor were then expelled into a 4 L nitrogen purged vessel. Volatile materials were removed from the polymers in a vacuum oven that gradually heated the polymer to 140° C. overnight and cooled to at least 50° C. prior to removal from the oven. After completion of the polymerization, the reactor was washed with 1200 mL mixed alkanes solvent at 150° C. before reuse. Results are contained in Table 2.

TABLE 2

| | | | Efficiency | | | |
|---|---|---|---|---|---|---|
| Run | Catalyst | Temp. (°C.) | (g/μg Zr) | Tm (°C.) | Mw | Mw/Mn |
| 8 | Ex. 3 | 70 | 1.1 | 156 | 373,000 | 1.96 |
| 9 | ″ | 85 | 1.0 | — | 196,000 | 2.24 |
| 10 | ″ | 100 | 0.7 | — | 132,000 | 2.14 |
| 11 | ″ | 115 | 0.3 | — | 32,000 | 2.89 |

1. A metal complex corresponding to the following formula: 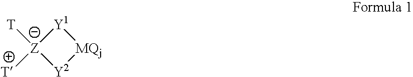
wherein:
M is titanium, zirconium, or hafnium in the +4, +3, or +2 oxidation state;
Y¹ and Y² are independently NR¹, PR¹, S, O, or an anionic, cyclic or non-cyclic, ligand group containing delocalized π-electrons;
Z is boron, aluminum, gallium or indium;
Q is a neutral, anionic or dianionic ligand group;
j is 1 or 2;
T independently each occurrence is:
NR¹₂, PR¹₂, hydrocarbyl, halohydrocarbyl, 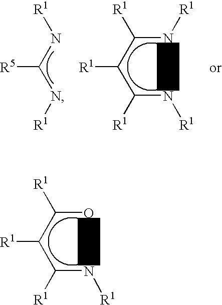
wherein:
R¹ is independently each occurrence hydrogen, a hydrocarbyl group, a halohydrocarbyl group, a tritydrocarbyl)silyl group, or a tri(hydrocarbyl)silylhydro carbyl group, said R¹ groups containing up to 20 atoms not counting hydrogen;
R⁵ is R¹ or N(R¹)₂; and
two R¹ groups together or one or more R¹ groups together with R⁵ may optionally be joined to form a ring structure,
T′⁺ is an ylide group, corresponding to the formula:
R¹₃N⁺CH₂—, R¹₃P⁺CH₂—, R¹₂S⁺CH₂—, R¹₃P⁺NR—, N≡N⁺CH₂—, or R⁴₂M′⁺CH₂—, wherein R¹ is as previously defined;
R⁴ is a cyclic π-bonded hydrocarbyl group;
M′ is a transition metal;
and optionally T and T′⁺ are covalently bonded together.

2. A metal complex according to claim 1 corresponding to the formula: 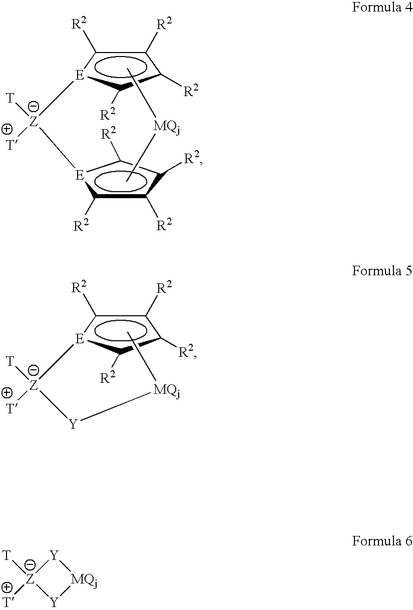
wherein,
M, Z⁻, T, T′⁺, Q and j are as defined in claim 1;
E is carbon, nitrogen, or phosphorous;
Y is NR¹ or PR¹, where R¹ is independently each occurrence hydrogen, a hydrocarbyl group, a halohydrocarbyl group, a triohydrocarbyl)silyl group, or a tri(hydrocarbyl)silylhydrocarbyl group, said R¹ groups containing up to 20 atoms not counting hydrogen, or two R¹ groups together may optionally be joined to form a ring structure,
R² is hydrogen, or a hydrocarbyl, halohydrocarbyl, dihydrocarbylamino-hydrocarbyl, tri(hydrocarbylsilyl)hydrocarbyl, Si(³)₃, N(R³)₂, or OR³ group of up to 20 carbon or silicon atoms, and optionally two adjacent R² groups can be joined together, thereby forming a fused ring structure; and
R³ is independently hydrogen, a hydrocarbyl group, a trihydrocarbylsilyl group or a tribydrocarbylsilylhydorcarbyl group, said R³ having up to 20 atoms not counting hydrogen, and optionally two R³ groups may be joined to form a ring structure.

3. A metal complex according to claim 2 wherein M is in the +4 oxidation state, j=2 and Q independently each occurrence is halide, hydride, hydrocarbyl, silylhydrocarbyl, hydrocarbyloxide, dihydrocarbylamide, said Q having up to 20 atoms not counting hydrogen, or, alternatively, j is 1 and Q is a hydrocarbadiyl-, or di(hydrocarbyl)silane group.

4. A metal complex according to claim 2 wherein M is in the +3 oxidation state, j=1 and Q is either 1) a monovalent anionic ligand selected from the group consisting of alkyl, cycloalkyl, aryl, silyl, amido, phosphido, alkoxy, aryloxy, sulfido groups, and mixtures thereof, optionally further substituted with an amine, phosphine, ether, or thioether containing substituent able to form a coordinate-covalent bond or chelating bond with M said ligand having up to 50 atoms not counting hydrogen; or 2) a C₃₋₁₀ hydrocarbyl group comprising an ethylenic unsaturation able to form an η³ bond with M.

5. A metal complex according to claim 2 wherein M is in the +2 oxidation state, j=1 and Q is a neutral conjugated diene, optionally substituted with one or more tri(hydrocarbyl)silyl or tri(hydrocarbylsilyl)hydrocarbyl groups, said Q having up to 40 carbon atoms and forming a π-complex with M.

6. A metal complex according to claim 2 corresponding to the formulas: 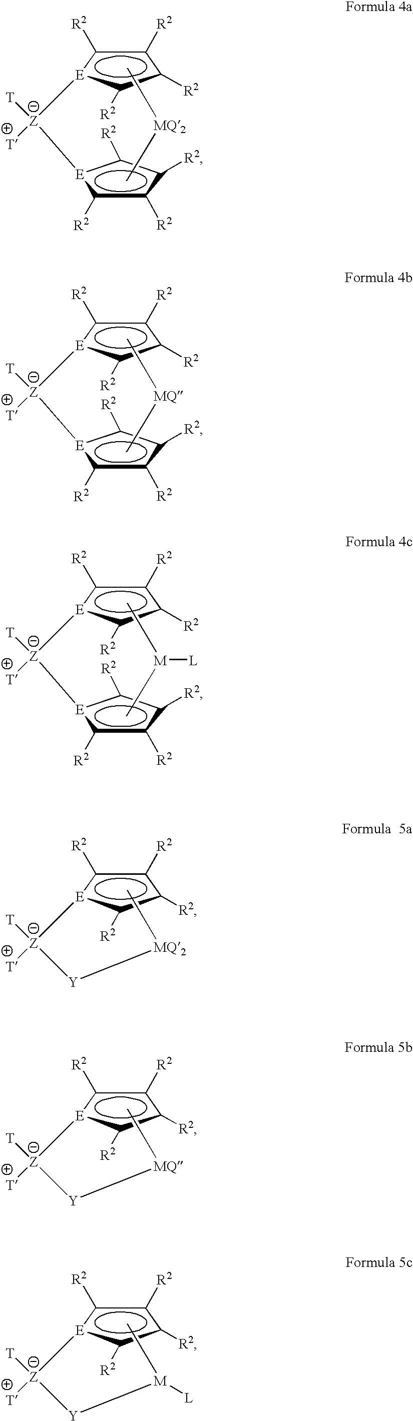 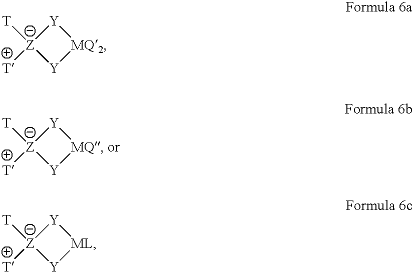
wherein:
M, Z, T, and T′⁺ are as previously defined in claim 1;
Y, E, and R² are as previously defined in claim 2;
Q′, independently each occurrence is a halide, hydrocarbyl, hydrocarbyloxy, or dihydrocarbylamide group of up to 10 atoms not counting hydrogen, or two Q′ groups together form a C₄₋₂₀ diene ligand coordinated to M in a metallocyclopentene fashion, or together are: —CH₂—C₆H₄—CH₂— or —CH₂—Si(CH₃)₂—CH₂—;
Q″ is a monovalent anionic stabilizing ligand selected from the group consisting of alkyl, cycloalkyl, aryl, and silyl groups which are optionally substituted with one or more amine, phosphine, or ether substituents able to form a coordinate-covalent bond or chelating bond with M, said Q″ having up to 30 non-hydrogen atoms; or Q″ is a C₃₋₁₀ hydrocarbyl group comprising an ethylenic unsaturation able to form an η³ bond with M; and
L is a neutral conjugated diene, optionally substituted with one or more tri(hydrocarbyl)silyl groups or tri(hydrocarbyl)silylhydrocarbyl groups, said L having up to 30 atoms not counting hydrogen and forming a π-complex with M.

7. A metal complex according to claim 1 wherein T′⁺ is triphenylphosphoniummethyleneylide or trimethylphosphoniummethyleneylide.

8. A metal complex according to claim 1 wherein 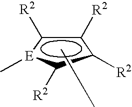
independently each occurrence is an unsubstituted, partially substituted or fully substituted indenyl-, fluorenyl-, indacenyl-, cyclopenta(l)phenanthrenyl-, or azuleneyl-group or a partially hydrogenated derivative thereof; or a partially or fully substituted cyclopentadienyl-, group, wherein each substituent is a hydrocarbyl-, halohydrocarbyl-, hydrocarbyloxy-, di(hydrocarbyl)amino-, hydrocarbyleneamino-, or silyl- group of from 1 to 20 atoms, not counting hydrogen.

9. A metal complex according to claim 8 wherein 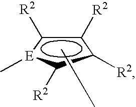
each occurrence is 3-(N-pyrrolyl)indene-1-yl, 3-(N,N-dimethylamino)indene-1-yl, 3-(N-3,4-benzopyrrolyl)indene-1-yl, 2-methyl-4-phenylindene-1-yl, 2-methyl4-(2-methylphenyl)indene-1-yl, 2-methyl-4-(3,5-dimethylphenyl)indene-1-yl, or 2-methyl-naphthylindene-1-yl.

10. An addition polymerization process comprising contacting one or more olefins, diolefins or a mixture thereof under polymerization conditions with a catalyst composition comprising a metal complex according to any one of claims 1-9.

11. The process of claim 10 wherein the catalyst composition additionally comprises an activating cocatalyst.

12. The process of claim 10 wherein the cocatalyst is a polymeric or oligomeric alumoxane.

13. The process of claim 10 conducted under solution, bulk, slurry or high pressure polymerization conditions.

14. The process of claim 10 wherein propylene, a mixture of propylene and an olefin other than propylene, a mixture of propylene and a diolefin, or a mixture of propylene, on olefin other than propylene and a diolefin is polymerized.

15. The process of claim 13 conducted under slurry polymerization conditions, wherein the catalyst additionally comprises an inert, particulated support.

16. The process of claim 13 conducted under gas phase polymerization conditions, wherein the catalyst additionally comprises an inert, particulated support.

17. A metal complex corresponding to the following formula: 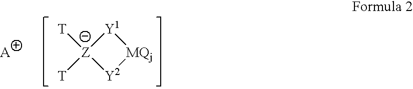
wherein:
M is titanium, zirconium, or hafnium in the +4, +3, or +2 oxidation state;
Y¹ and Y² are independently NR¹, PR¹, S, O, or an anionic, cyclic or non-cyclic, ligand group containing delocalized π-electrons;
Z is boron, aluminum, gallium or indium;
Q is a neutral, anionic or dianionic ligand group;
j is 1 or 2;
T independently each occurrence is NR¹₂, PR¹₂, hydrocarbyl, halohydrocarbyl, 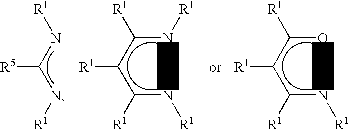
wherein:
R¹ is independently each occurrence hydrogen, a hydrocarbyl group, a halohydrocarbyl group, a tri(hydrocarbyl)silyl group, or a tri(hydrocarbyl)silylhydrocarbyl group, said R¹ groups containing up to 20 atoms not counting hydrogen;
R⁵ is R¹ or N(R¹)₂; and
two R¹ groups together or one or more R¹ groups together with R⁵ may optionally be joined to form a ring structure, and
A⁺ is an alkali metal, alkaline earth metal, Grignard, or C₁₋₂₀ mono-, di- or tri-alkyl ammonium cation.

18. A metal complex corresponding to the following formula: 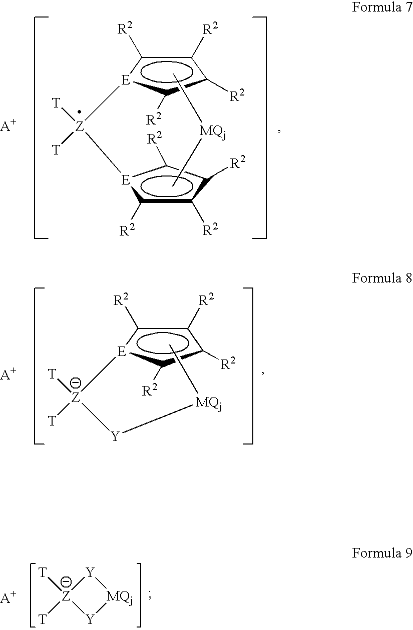
wherein,
A⁺, M, Z⁻, T, T′⁺, Q and j are as defined in claim 17;
E is carbon, nitrogen, or phosphorous;
Y is NR¹ or PR¹, where R¹ is as previously defined in claim 1;
R² is hydrogen, or a hydrocarbyl, halohydrocarbyl, dihydrocarbylamino-hydrocarbyl, tri(hydrocarbylsilyl)hydrocarbyl, Si(R³)₃, N(R³)₂, or OR³ group of up to 20 carbon or silicon atoms, and optionally two adjacent R² groups can be joined together, thereby forming a fused ring structure; and
R³ is independently hydrogen, a hydrocarbyl group, a trihydrocarbylsilyl group or a trihydrocarbylsilylhydrocarbyl group, said R³ having up to 20 atoms not counting hydrogen, and optionally two R³ groups may be joined to form a ring structure.
